(19) United States
(12) Patent Application Publication
(10) Pub. No.: US 2024/0161468 A1
(43) Pub. Date: May 16, 2024

(54) TECHNIQUES FOR GENERATING IMAGES OF OBJECT INTERACTIONS

(71) Applicant: NVIDIA CORPORATION, Santa Clara, CA (US)

(72) Inventors: Xueting LI, Santa Clara, CA (US); Stanley BIRCHFIELD, Sammamish, WA (US); Shalini DE MELLO, San Francisco, CA (US); Sifei LIU, Santa Clara, CA (US); Jiaming SONG, San Carlos, CA (US); Yufei YE, Pittsburgh, PA (US)

(21) Appl. No.: 18/453,248

(22) Filed: Aug. 21, 2023

Related U.S. Application Data
(60) Provisional application No. 63/384,080, filed on Nov. 16, 2022.

(51) Int. Cl. G06V 10/774; G06T 5/00; G06T 7/11; G06V 10/82; G06V 40/10

(52) U.S. Cl. CPC G06V 10/774; G06T 5/002; G06T 5/005; G06T 7/11; G06V 10/82; G06V 40/11; G06T 2207/20081; G06T 2207/20084; G06T 2207/30196

(57) ABSTRACT

Techniques are disclosed herein for generating an image. The techniques include performing one or more first denoising operations based on a first machine learning model and an input image that includes a first object to generate a mask that indicates a spatial arrangement associated with a second object interacting with the first object, and performing one or more second denoising operations based on a second machine learning model, the input image, and the mask to generate an image of the second object interacting with the first object.

### CROSS-REFERENCE TO RELATED APPLICATIONS

This application claims priority benefit of the United States Provisional Patent Application titled, “HAND-OBJECT AFFORDANCE PREDICTION BEYOND HEATMAP,” filed on Nov. 16, 2022, and having Ser. No. 63/384,080. The subject matter of this related application is hereby incorporated herein by reference.

### BACKGROUND

### Technical Field

Embodiments of the present disclosure relate generally to artificial intelligence/machine learning and computer graphics and, more specifically, to techniques for generating images of object interactions.

### Description of the Related Art

Generative models are computer models that can generate representations or abstractions of previously observed phenomena. Image denoising diffusion models are one type of generative model that can generate images. Conventional image denoising diffusion models generate images via an iterative process that includes removing noise from a noisy image using a trained artificial neural network, adding back a smaller amount of noise than was present in the noisy image, and then repeating these steps until a clean image that does not include much or any appreciable noise is generated.

One drawback of conventional image denoising diffusion models is that, oftentimes, these models do not generate realistic images of objects interacting with one another. For example, generating a realistic image of a hand grasping an object requires determining feasible locations on the object that can be grasped, the size of the hand relative to the object, the orientation of the hand, and the points of contact between the hand and the object. Conventional image denoising diffusion models are unable to make these types of determinations, because conventional image denoising diffusion models can only predict pixel colors. As a result, conventional image denoising diffusion models can end up generating images of object interactions that appear unrealistic.

One approach for generating a more realistic image of an object interaction is to have a user specify where a second object should reside relative to a first object within a given image. Returning to the above example of a hand grasping an object, a user could specify a region within an original image that includes the first object and prompt a conventional image denoising diffusion model to generate a hand grasping the first object within the user-specified region. The conventional image denoising diffusion model could then generate a new image that replaces the content of the user-specified region in the original image with new content that includes a hand grasping the first object.

One drawback of relying on a user-specified region is the user can specify a region of the original image that includes part of the first object. In such a case, when the denoising diffusion model generates the new image, the denoising diffusion model will replace the content in the user-specified region, including the part of the first object, with new content that includes the second object interacting with the first object. However, in the new content, the denoising diffusion model may not accurately recreate the part of the first object in the user-specified region of the original image, because the denoising diffusion model generates the new content based on the rest of the original image and the prompt. Accordingly, the appearance of the first object in the new image, generated using the image denoising diffusion model, can be different from the appearance of the first object in the original image, particularly in the user-specified region.

More generally, being able to generate realistic images of certain types of object interactions, such as images of hands or other body parts interacting with objects, can be highly desirable, particularly if human intervention is not required to, for example, specify regions where the hands or other body parts are located in the images. However, few if any conventional approaches exist for generating realistic images of object interactions without requiring human intervention because of the difficulty of generating such images.

As the foregoing illustrates, what is needed in the art are more effective techniques for generating images of object interactions.

### SUMMARY

One embodiment of the present disclosure sets forth a computer-implemented method for generating an image. The method includes performing one or more first denoising operations based on a first machine learning model and an input image that includes a first object to generate a mask that indicates a spatial arrangement associated with a second object interacting with the first object. The method further includes performing one or more second denoising operations based on a second machine learning model, the input image, and the mask to generate an image of the second object interacting with the first object.

Other embodiments of the present disclosure include, without limitation, one or more computer-readable media including instructions for performing one or more aspects of the disclosed techniques as well as one or more computing systems for performing one or more aspects of the disclosed techniques.

At least one technical advantage of the disclosed techniques relative to the prior art is that, with the disclosed techniques, an image of objects interacting with one another can be generated without changing the appearance of any of the objects. In addition, the disclosed techniques enable the automatic generation of images that include more realistic interactions between objects, such as a human hand or other body part interacting with an object, relative to what can be achieved using conventional techniques. These technical advantages represent one or more technological improvements over prior art approaches.

### BRIEF DESCRIPTION OF THE DRAWINGS

So that the manner in which the above recited features of the various embodiments can be understood in detail, a more particular description of the inventive concepts, briefly summarized above, may be had by reference to various embodiments, some of which are illustrated in the appended drawings. It is to be noted, however, that the appended drawings illustrate only typical embodiments of the inventive concepts and are therefore not to be considered limiting of scope in any way, and that there are other equally effective embodiments.

FIG. 1 is a block diagram illustrating a computer system configured to implement one or more aspects of the various embodiments;

FIG. 2 is a more detailed illustration of the computing device of FIG. 1, according to various embodiments;

FIG. 3 is a more detailed illustration of how the image generating application of FIG. 1 generates an image of objects interacting with one another, according to various embodiments;

FIG. 4 is a more detailed illustration of how the layout model of FIG. 1 generates a parameter vector associated with a layout mask, according to various embodiments;

FIG. 5 illustrates an exemplar layout mask and associated parameters, according to various embodiments;

FIG. 6 is a more detailed illustration of how the content model of FIG. 1 generates an image of objects interacting with one another, according to various embodiments;

FIG. 7 illustrates how training images are generated for training the content model of FIG. 1, according to various embodiments;

FIG. 8A illustrates exemplar images generated using a denoising diffusion model and a user-specified region, according to the prior art;

FIG. 8B illustrates exemplar images generated using a layout model in conjunction with a content model, according to various embodiments;

FIG. 9 illustrates another exemplar image generated using a layout model in conjunction with a content model, according to other various embodiments;

FIG. 10 is a flow diagram of method steps for training a layout model to generate a mask indicating the spatial arrangement of two interacting objects, according to various embodiments;

FIG. 11 is a flow diagram of method steps for training a content model to generate an image of objects interacting with one another, according to various embodiments; and

FIG. 12 is a flow diagram of method steps for generating an image of objects interacting with one another, according to various embodiments.

### DETAILED DESCRIPTION

In the following description, numerous specific details are set forth to provide a more thorough understanding of the various embodiments. However, it will be apparent to one skilled in the art that the inventive concepts may be practiced without one or more of these specific details.

### General Overview

Embodiments of the present disclosure provide techniques for generating images of objects interacting with one another. Given an input image that includes a first object, an image generating application performs denoising diffusion using a layout model and conditioned on the input image to generate a vector of parameters that indicates a spatial arrangement of a second object interacting with the first object. Then, the image generating application converts the vector of parameters into a layout mask and performs denoising diffusion using a content model and conditioned on (1) the input image, and (2) the layout mask to generate an image of the second object interacting with the first object. In some embodiments, a user can also input a location associated with the second object. In such cases, the image generating application performs denoising diffusion using the layout model and conditioned on (1) the input image, and (2) the input location to generate the vector of parameters, which can then be used to generate an image of the second object interacting with the first object.

The techniques disclosed herein for generating images of objects interacting with one another have many real-world applications. For example, those techniques could be used to generate images for a video game. As another example, those techniques could be used for generating photos based on a text prompt, image editing, image inpainting, image outpainting, generating three-dimensional (3D) models, and/or production-quality rendering of films.

The above examples are not in any way intended to be limiting. As persons skilled in the art will appreciate, as a general matter, the techniques for generating images using one or more ensembles of expert denoisers can be implemented in any suitable application.

### System Overview

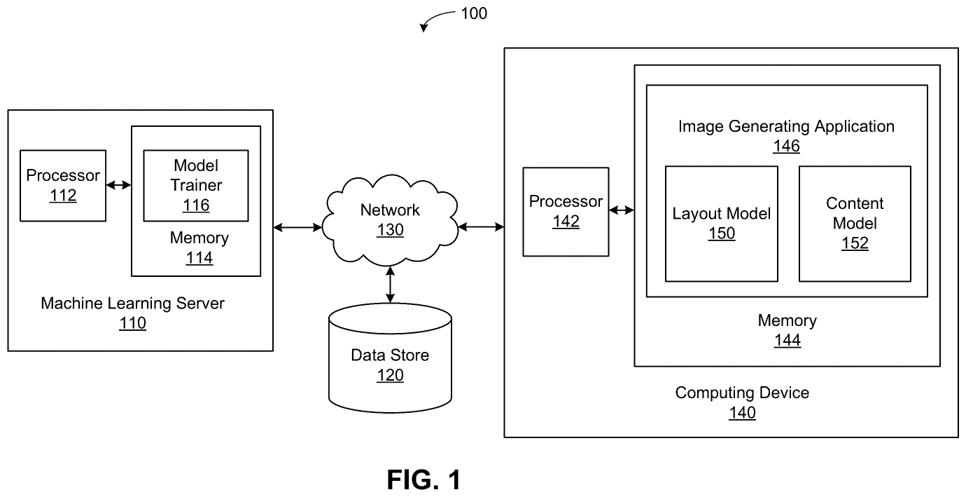

FIG. 1 is a block diagram illustrating a computer system 100 configured to implement one or more aspects of the various embodiments. As shown, the system 100 includes a machine learning server 110, a data store 120, and a computing device 140 in communication over a network 130, which can be a wide area network (WAN) such as the Internet, a local area network (LAN), or any other suitable network.

As shown, a model trainer 116 executes on a processor 112 of the machine learning server 110 and is stored in a system memory 114 of the machine learning server 110. The processor 112 receives user input from input devices, such as a keyboard or a mouse. In operation, the processor 112 is the master processor of the machine learning server 110, controlling and coordinating operations of other system components. In particular, the processor 112 can issue commands that control the operation of a graphics processing unit (GPU) (not shown) that incorporates circuitry optimized for graphics and video processing, including, for example, video output circuitry. The GPU can deliver pixels to a display device that can be any conventional cathode ray tube, liquid crystal display, light-emitting diode display, or the like.

The system memory 114 of the machine learning server 110 stores content, such as software applications and data, for use by the processor 112 and the GPU. The system memory 114 can be any type of memory capable of storing data and software applications, such as a random access memory (RAM), a read-only memory (ROM), an erasable programmable read-only memory (EPROM or Flash ROM), or any suitable combination of the foregoing. In some embodiments, a storage (not shown) can supplement or replace the system memory 114. The storage can include any number and type of external memories that are accessible to the processor 112 and/or the GPU. For example, and without limitation, the storage can include a Secure Digital Card, an external Flash memory, a portable compact disc read-only memory (CD-ROM), an optical storage device, a magnetic storage device, or any suitable combination of the foregoing.

It will be appreciated that the machine learning server 110 shown herein is illustrative and that variations and modifications are possible. For example, the number of processors 112, the number of GPUs, the number of system memories 114, and the number of applications included in the system memory 114 can be modified as desired. Further, the connection topology between the various units in FIG. 1 can be modified as desired. In some embodiments, any combination of the processor 112, the system memory 114, and a GPU can be replaced with any type of virtual computing system, distributed computing system, or cloud computing environment, such as a public, private, or a hybrid cloud.

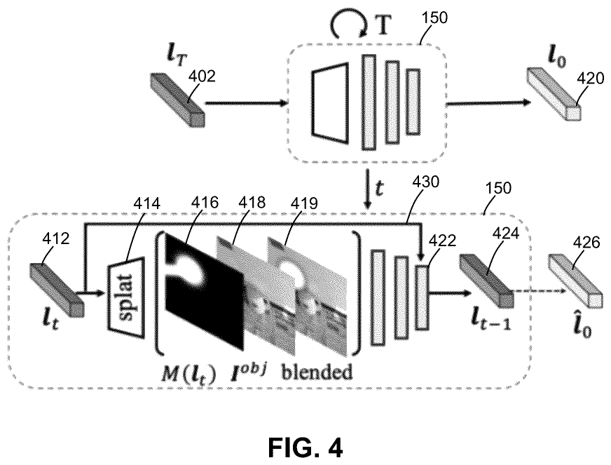

In some embodiments, the model trainer 116 is configured to train one or more machine learning models, including a content model 150 and a layout model 152. Architectures of the content model 150 and the layout model 152, as well as techniques for training the same, are discussed in greater detail below in conjunction with FIGS. 4, 6-7, and 10-11. Training data and/or trained machine learning models can be stored in the data store 120. In some embodiments, the data store 120 can include any storage device or devices, such as fixed disc drive(s), flash drive(s), optical storage, network attached storage (NAS), and/or a storage area-network (SAN). Although shown as accessible over the network 130, in some embodiments the machine learning server 110 can include the data store 120.

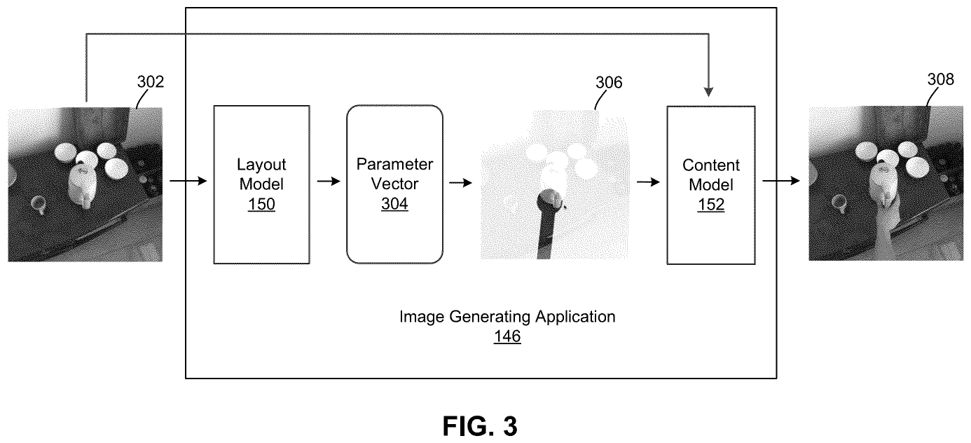

As shown, an image generating application 146 is stored in a memory 144, and executes on a processor 142, of the computing device 140. The image generating application 146 uses the content model 150 and the layout model 152 to generate images of objects interacting with one another, as discussed in greater detail below in conjunction with FIGS. 3-6 and 12. In some embodiments, machine learning models, such as the content model 150 and the layout model 152, that are trained according to techniques disclosed herein can be deployed to any suitable applications, such as the image generating application 146.

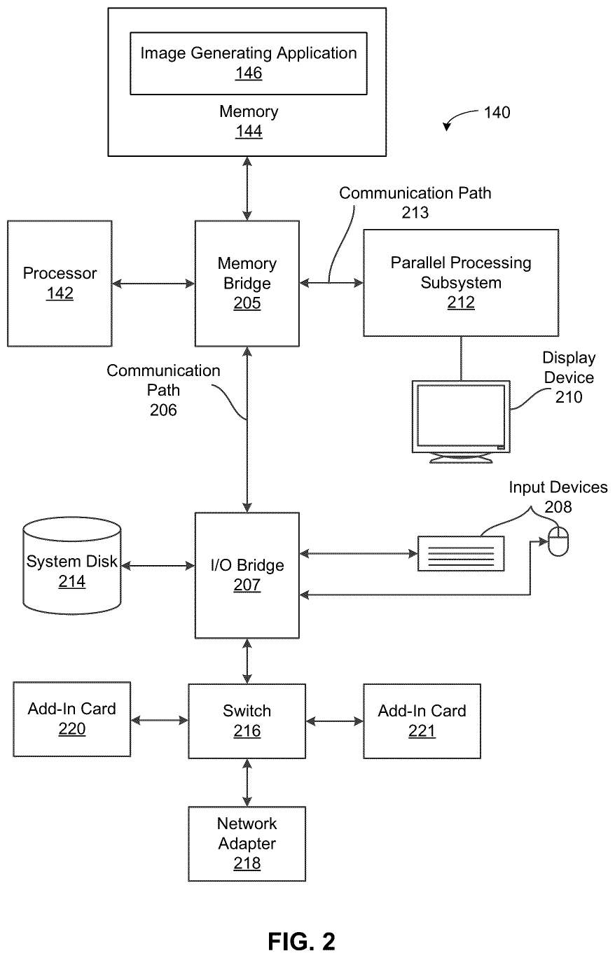

FIG. 2 is a more detailed illustration of the computing device 140 of FIG. 1, according to various embodiments. As persons skilled in the art will appreciate, computing device 140 can be any type of technically feasible computer system, including, without limitation, a server machine, a server platform, a desktop machine, a laptop machine, a hand-held/mobile device, or a wearable device. In some embodiments, computing device 140 is a server machine operating in a data center or a cloud computing environment that provides scalable computing resources as a service over a network. In some embodiments, the machine learning server 110 can include similar components as the computing device 140.

In various embodiments, the computing device 140 includes, without limitation, the processor 142 and the memory 144 coupled to a parallel processing subsystem 212 via a memory bridge 205 and a communication path 213. Memory bridge 205 is further coupled to an I/O (input/output) bridge 207 via a communication path 206, and I/O bridge 207 is, in turn, coupled to a switch 216.

In one embodiment, I/O bridge 207 is configured to receive user input information from optional input devices 208, such as a keyboard or a mouse, and forward the input information to processor 142 for processing via communication path 206 and memory bridge 205. In some embodiments, computing device 140 may be a server machine in a cloud computing environment. In such embodiments, computing device 140 may not have input devices 208. Instead, computing device 140 may receive equivalent input information by receiving commands in the form of messages transmitted over a network and received via the network adapter 218. In one embodiment, switch 216 is configured to provide connections between I/O bridge 207 and other components of the computing device 140, such as a network adapter 218 and various add-in cards 220 and 221.

In one embodiment, I/O bridge 207 is coupled to a system disk 214 that may be configured to store content and applications and data for use by processor 142 and parallel processing subsystem 212. In one embodiment, system disk 214 provides non-volatile storage for applications and data and may include fixed or removable hard disk drives, flash memory devices, and CD-ROM (compact disc read-only-memory), DVD-ROM (digital versatile disc-ROM), Blu-ray, HD-DVD (high definition DVD), or other magnetic, optical, or solid state storage devices. In various embodiments, other components, such as universal serial bus or other port connections, compact disc drives, digital versatile disc drives, film recording devices, and the like, may be connected to I/O bridge 207 as well.

In various embodiments, memory bridge 205 may be a Northbridge chip, and I/O bridge 207 may be a Southbridge chip. In addition, communication paths 206 and 213, as well as other communication paths within computing device 140, may be implemented using any technically suitable protocols, including, without limitation, AGP (Accelerated Graphics Port), HyperTransport, or any other bus or point-to-point communication protocol known in the art.

In some embodiments, parallel processing subsystem 212 comprises a graphics subsystem that delivers pixels to an optional display device 210 that may be any conventional cathode ray tube, liquid crystal display, light-emitting diode display, or the like. In such embodiments, the parallel processing subsystem 212 incorporates circuitry optimized for graphics and video processing, including, for example, video output circuitry. As described in greater detail below in conjunction with FIGS. 2-3, such circuitry may be incorporated across one or more parallel processing units (PPUs), also referred to herein as parallel processors, included within parallel processing subsystem 212. In other embodiments, the parallel processing subsystem 212 incorporates circuitry optimized for general purpose and/or compute processing. Again, such circuitry may be incorporated across one or more PPUs included within parallel processing subsystem 212 that are configured to perform such general purpose and/or compute operations. In yet other embodiments, the one or more PP Us included within parallel processing subsystem 212 may be configured to perform graphics processing, general purpose processing, and compute processing operations. System memory 144 includes at least one device driver configured to manage the processing operations of the one or more PPUs within parallel processing subsystem 212. In addition, the system memory 144 includes the image generating application 146, described in greater detail in conjunction with FIGS. 1, 3-4, 6, and 12.

In various embodiments, parallel processing subsystem 212 may be integrated with one or more of the other elements of FIG. 1 to form a single system. For example, parallel processing subsystem 212 may be integrated with processor 142 and other connection circuitry on a single chip to form a system on chip (SoC).

In one embodiment, processor 142 is the master processor of computing device 140, controlling and coordinating operations of other system components. In one embodiment, processor 142 issues commands that control the operation of PPUs. In some embodiments, communication path 213 is a PCI Express link, in which dedicated lanes are allocated to each PPU, as is known in the art. Other communication paths may also be used. PPU advantageously implements a highly parallel processing architecture. A PPU may be provided with any amount of local parallel processing memory (PP memory).

It will be appreciated that the system shown herein is illustrative and that variations and modifications are possible. The connection topology, including the number and arrangement of bridges, the number of processors (e.g., processor 142), and the number of parallel processing subsystems 212, may be modified as desired. For example, in some embodiments, system memory 144 could be connected to processor 142 directly rather than through memory bridge 205, and other devices would communicate with system memory 144 via memory bridge 205 and processor 142. In other embodiments, parallel processing subsystem 212 may be connected to I/O bridge 207 or directly to processor 142, rather than to memory bridge 205. In still other embodiments, I/O bridge 207 and memory bridge 205 may be integrated into a single chip instead of existing as one or more discrete devices. In certain embodiments, one or more components shown in FIG. 1 may not be present. For example, switch 216 could be eliminated, and network adapter 218 and add-in cards 220, 221 would connect directly to I/O bridge 207. Lastly, in certain embodiments, one or more components shown in FIG. 1 may be implemented as virtualized resources in a virtual computing environment, such as a cloud computing environment. In particular, the parallel processing subsystem 212 may be implemented as a virtualized parallel processing subsystem in some embodiments. For example, the parallel processing subsystem 212 could be implemented as a virtual graphics processing unit (GPU) that renders graphics on a virtual machine (VM) executing on a server machine whose GPU and other physical resources are shared across multiple VMs.

### Generating Images of Object Interactions

FIG. 3 is a more detailed illustration of how the image generating application 146 of FIG. 1 generates an image of objects interacting with one another, according to various embodiments. As shown, the image generating application 146 includes the layout model 150 and the content model 152. Given an image of a first object, the goal is to synthesize image(s) of a second object interacting with the first object. Generating an image of a second object interacting with a first object given an image of the first object is also sometimes referred to as “affordance.” In some embodiments, the image generating application 146 employs a two-step technique to generate images of object interactions in which (1) the layout model 150 is first used to predict plausible spatial arrangements of the second object in relation to the first object in the image, which is also referred to herein as a “layout” and can be in the form of a proxy, specified by a parameter vector, that abstracts away the appearance of the second object; and (2) given the image of the first object and the layout generated using the layout model 150, the content model 152 is used to generate image(s) with plausible appearances of the second object interacting with the first object. In some embodiments, each of the layout model 150 and the content model 152 can be a conditional diffusion model, which can be used to generate high-quality layout and visual content, respectively.

As shown, the image generating application 146 receives as input an image of an object. An image 302 of a kettle is shown for illustrative purposes. Given the image 132, the image generating application 146 performs denoising diffusion using the layout model 150, and conditioned on the image 302, to generate a parameter vector 304. The layout model 150 is a diffusion model, and an architecture of the layout model 150 is described in greater detail below in conjunction with FIG. 4. In some embodiments, the parameter vector 304 generated using the layout model 150 includes parameters indicating a layout of the second object interacting with the first object, such as the size, position, and/or approaching direction of the second object. For example, when the second object is a human hand, the parameter vector 304 can include the following parameters: a hand palm size, a location, an approaching direction, and a ratio of the hand palm size and a forearm width. Although described herein primarily with respect to a human hand as a reference example, in some embodiments, the layout model 150 and the content model 152 can be used to generate images of any suitable second object (e.g., a body part other than a hand) interacting with a first object.

In some embodiments, the image generating application 146 also receives as input a user-specified location associated with the second object. Returning to the example of a hand, the user-specified location could be the center of a palm of the hand. Given the user-specified location, the image generating application 146 can perform denoising diffusion using the layout model 150 and conditioned on (1) the input image, and (2) the user-specified location, to generate a parameter vector that includes the user-specified location and other parameter values (e.g., in the case of a human hand, the other parameter values can include a hand palm size, an approaching direction, and a ratio of the hand palm size and a forearm width) that are similar to parameter values of the parameter vector 420, described above.

As shown, the image generating application 146 converts the parameter vector 304, generated using the layout model 150, into a layout mask 306 that indicates a spatial arrangement of the second object interacting with the first object. In some embodiments in which the second object is a human hand, the layout mask 306 includes a lollipop proxy in the form of a circle connected to a stick, representing a hand and an arm, and the layout mask 306 indicates where the hand should be, as specified by the parameter vector 304. It should be noted that the abstraction provided by the lollipop proxy allows global reasoning of hand-object relations and also enables users to specify the interactions, such as a position associated with a center of the palm of the hand in the lollipop proxy.

After generating the layout mask 306, the image generating application 146 performs denoising diffusion using the content model 152 and conditioned on (1) the input image 302 and (2) the layout mask 306, to generate an image of the second object interacting with the first object, shown as an image 308 of a hand grasping a kettle.

More formally, diffusion models, such as the layout model 150 and the content model 152, are probabilistic models that learn to generate samples from a data distribution p(x) by sequentially transforming samples from a tractable distribution p(x_{T}) (e.g., a Gaussian distribution). There are two processes in diffusion models: 1) a forward noise process q(xₜ|xₜ₋₁) that gradually adds a small amount of noise and degrades clean data samples towards the prior Gaussian distribution; and 2) a learnable backward denoising process p(xₜ₋₁|xₜ) that is trained to remove the added noise. The backward process can be implemented as a neural network in some embodiments. During inference, a noise vector x_{T} is sampled from the Gaussian prior and is sequentially denoised by the learned backward model.

FIG. 4 is a more detailed illustration of how the layout model 150 of FIG. 1 generates a parameter vector associated with a layout mask, according to various embodiments. As shown, starting with a random parameter vector 402, denoted by l_{T}, that includes randomly sampled parameter values, the image generating application 146 uses the layout model 150 to generate a parameter vector 420, denoted by l₀, that includes parameters indicating a layout of a second object interacting with a first object. To generate the parameter vector 420, the image generating application 146 performs an iterative denoising diffusion technique in which, at each time step t, a parameter vector 412 (beginning with the random parameter vector 402), denoted by lₜ, is splat using a machine learning model 414 to generate a layout mask 416 corresponding to the parameter vector 412. In some embodiments, the machine learning model 414 used to splat the parameter vector 412 can be a spatial transformer network. Illustratively, the layout mask 416 includes a lollipop representation of a hand and indicates the layout of the hand according to the parameter vector 412.

The image generating application 146 inputs a concatenation of (1) the layout mask 416, an (2) image of a first object 418, and (3) a blended combination 419 of the layout mask 416 and the image of a first object 418 into a trained denoiser model 422. In some embodiments, the denoiser model 422 can be the neural network, described above in conjunction with FIG. 3. In some embodiments, the denoiser model 422 can be an encoder neural network. As shown, the parameter vector 412 is also fused into the last layer of the denoiser model 422 by perform cross-attention between the parameter vector 412 and the feature grid of the bottleneck of the denoiser model 422. The denoiser model 422 outputs a denoised parameter vector 424, denoted by lₜ₋₁, for a next iteration of the denoising diffusion technique. In some embodiments, the denoiser model 422 outputs noise, and a clean parameter vector can be computed by subtracting the noise that is output by the denoiser model 422 from the parameter vector 424, lₜ₋₁. In some other embodiments, the denoiser model 422 can be trained to output a clean parameter vector. In some embodiments, the image generating application 146 continues iterating for a fixed number of time steps consistent with the forward (adding noise) procedure being used, in order to generate the parameter vector 420, l₀, that does not include noise.

More formally, given an image I^{obj} that includes a first object (also referred to herein as the “object image”), the layout model 150 is trained to generate a plausible layout l from a learned distribution p(l|I^{obj}). In some embodiments, the layout model 150 follows the diffusion model regime that sequentially denoises a noisy layout parameter to output a final layout. For every denoising step, the layout model 150 takes as input a (noisy) layout parameter, shown as the parameter vector 412, lₜ, along with the object image I^{obj}, denoises the layout parameter sequentially, i.e., lₜ₋₁˜ϕ(lₜ₋₁|lₜ, I^{obj}), and outputs a denoised layout vector lₜ₋₁ (where l₀=l). As described, the imaging generating application 146 splats the layout parameter into the image space M(lₜ) in order to better reason about two-dimensional (2D) spatial relationships to the object image I^{obj}. The splatting, which in some embodiments can be performed using a spatial transformer network that transforms a canonical mask template by a similarity transform, generates a layout mask that can then be concatenated with the object image and passed to the denoiser model 422.

In some embodiments, the denoiser model 422 that is the backbone network can be implemented as the encoder (i.e., the first half) of a UNet, or similar neural network, with cross-attention layers. In such cases, the denoiser model 422 can take as input images with seven channels, 3 for the image 418, 1 for the splatted layout mask 416, and another 3 for the blended combination 419 of the layout mask 416 and the image 418. The noisy layout parameter attends spatially to the feature grid from the bottleneck of the denoiser model 422 and outputs the denoised output.

Training of a diffusion model, such as the layout model 150 or the content model 152, can generally be treated as training a denoising autoencoder for L2 loss at various noise levels, i.e., denoise x₀ for different xₜ given t. The loss from the Denoising Diffusion Probabilistic Models (DDPM), which reconstructs the added noise that corrupted input samples, can be used during training. Let [symbol] _{DDPM} [x; c] denote a DDPM loss term that performs diffusion over the data x but is also conditioned on data c, which are not diffused or denoised:

$${ℒ}_{DDPM} [ x ; c ] = {𝔼}_{( x , c ) , ϵ ∼ 𝒩 ( 0 , I ) , t} {‖ x - {D}_{θ} ( {x}_{t} , t , c ) ‖}_{2}^{2} , \qquad ( 1 )$$

where xₜ is a linear combination of the data x and noise ϵ, and D_{θ} is a denoiser model that takes in the noisy data xₜ, time t, and condition c. For the unconditional case, c can be set as a null token, such as Ø.

In some embodiments, the layout model 150 is not only trained using the DDPM loss of equation (1) in the layout parameter space [symbol] ₚₐᵣₐ:= [symbol] _{DDPM} [l; I^{obj}]. When diffusing in such a space, multiple parameters can induce an identical layout, such as a size parameter with opposite signs or approaching directions that are scaled by a constant. The DDPM loss of equation (1) would penalize predictions even if the predictions guide the parameter to an equivalent prediction that induces the same layout masks as the ground truth. As the content model 152 only takes splatted masks as input and not a parameter vector, the model trainer 116 can train the layout model 150 using the DDPM loss applied in the splatted image space:

$${ℒ}_{mask} = {𝔼}_{( {l}_{0} , {I}^{obj} ) , ϵ ∼ 𝒩 ( 0 , I ) , t} {‖ M ( {l}_{0} ) - M ( {\hat{I}}_{0} ) ‖}_{2}^{2} , \qquad ( 2 )$$

where \hat{l}₀:=D_{θ}(lₜ, t, I^{obj}) is the output of the trained denoiser model 422 that takes in the current noisy layout lₜ, the time t, and the object image I^{obj} for conditioning. Further, in some embodiments, the model trainer 116 can apply losses in both the parameter space and the image space

[symbol]

ₘₐₛₖ+λ [symbol] ₚₐᵣₐ, (3)

because, when the layout parameters are very noisy in the early diffusion steps, the splatted loss in 2D alone can be too weak of a training signal. In some embodiments, the denoiser model 422 is initialized from a pretrained diffusional model, and the layout model 150 is then trained using the loss of equation (3).

As described, in some embodiments, the image generating application 146 can also receive as input a user-specified location associated with a second object, such as the center of the palm of a hand. Given the user-specified location, the image generating application 146 can perform denoising diffusion using the layout model 150 and conditioned on (1) the input image, and (2) the user-specified location, to generate a parameter vector. In such cases, the layout model 150 can be trained to be conditioned on an image of a first object only. However, during inference using the trained layout model 150, the generation of images can be guided with additional conditions, without retraining the layout model 150. For example, in some embodiments, the layout model 150 can be conditioned to generate layouts so that locations of second objects are at certain places, such as the user-specified locations, i.e., l˜p(l₀|I^{obj}, x=x₀, y=y₀), by hijacking the conditions after each diffusion step with corresponding noise levels.

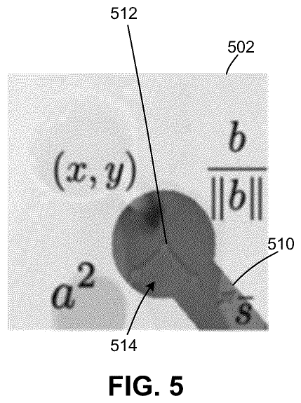

FIG. 5 illustrates an exemplar layout mask and associated parameters, according to various embodiments. As described, in some embodiments, a parameter vector can include parameters indicating a layout of a second object interacting with a first object. As shown, a layout mask 502 includes a lollipop representation of a hand 502, which is the second object in this example, and the layout mask 502 indicates the layout of the hand interacting with a cup.

In images of hands interacting with objects, the hands oftentimes appear as hands (from wrist to fingers) with forearms. Accordingly, some embodiments use a parameter vector that is an articulation-agnostic hand proxy, namely a lollipop, that preserves only this basic structure. Illustratively, in some embodiments, the parameter vector, which as described can be splat into the layout mask 502, includes a hand palm size a², location x, y and approaching direction arctan(b₁, b₂), i.e., l:=(a, x, y, b₁, b₂). In such cases, the ratio of hand palm size and forearm width s̅ can be a constant that is set to the mean value over the training set. For training purposes, the ground truth parameters can be obtained from hand detection (for location and size) and hand/forearm segmentation (for orientation).

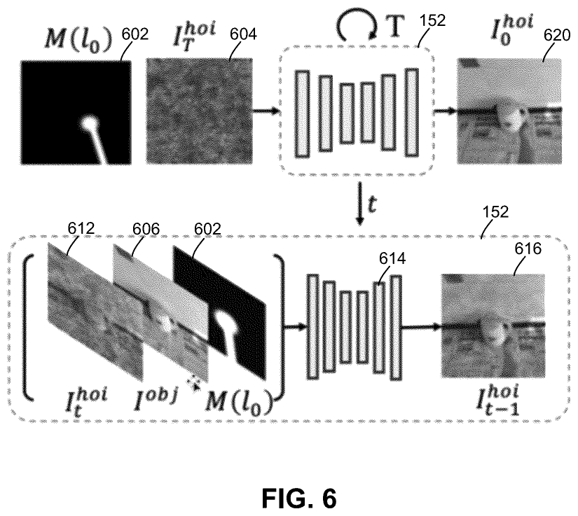

FIG. 6 is a more detailed illustration of how the content model 152 of FIG. 1 generates an image of objects interacting with one another, according to various embodiments. As shown, starting with (1) a layout mask 602, denoted by M(l₀), that is generated by splatting a parameter vector output by the layout model 150; and (2) an image 604 that includes random noise, denoted by I_{T}^{hoi}, and conditioned on an input image 606 that includes a first object, denoted by I^{obj}, the image generating application 146 uses the content model 152 to generate an image 620, denoted by I₀^{hoi}, that includes a second object interacting with the first object. In the example image 620, I₀^{hoi}, the first object is a kettle and the second object is a hand grabbing the kettle.

To generate the image 620, the image generating application 146 performs an iterative denoising diffusion technique in which, at each time step t, the image generating application 146 inputs (1) a noisy image 612 (beginning with the image 604 that includes random noise), denoted by Iₜ^{hoi}; (2) the input image 606, I^{obj}; and (3) the layout mask 602, M(l₀), into a trained denoiser model 614 that outputs a noisy image 616, denoted by Iₜ₋₁^{hoi}, for a next iteration of the denoising diffusion technique. In some embodiments, the denoiser model 614 can be an encoder-decoder neural network. The image generating application 146 continues iterating for a number of time steps consistent with the forward (adding noise) procedure being used, in order to generate a clean image 606 I₀^{hoi} that does not include a substantial amount of noise.

More formally, given (1) the sampled layout l generated by splatting the parameter vector output by the layout model 150, and (2) the image I^{obj} of the first object, the content model 1512 synthesizes an image I^{hoi} in which a second object interacts with the first object. While the synthesized image should respect the provided layout, the generation of the image I^{hoi} is still stochastic when appearances of the second object can vary. Returning to the example of a hand grasping an object, hand appearances can vary in shape, finger articulation, skin color, etc. In some embodiments, the denoiser model 614 can be implemented as an image-conditional diffusion model. In such cases, at each step of diffusion, the denoiser model 614 takes as input a channel-wise concatenation of a noisy image of a second object interacting with a first object, the image of the first object, and the splatted layout mask, and the denoiser model 614 outputs the denoised images D_{ϕ}(Iₜ^{hoi}, t, [I^{obj}, M(l)]) IN.

In some embodiments, the image-conditioned diffusion model is implemented in a latent space and fine-tuned from an inpainting model that is pre-trained on a large-scale data set. The pre-training can be beneficial because the model will have learned the prior of retraining the pixels in an unmasked region indicated by the layout mask and hallucinate to full a masked region indicated by the layout mask. During fine-tuning, the model can further learn to respect the layout mask, i.e., retraining the object appearance if not occluded by the second object (e.g., a hand) and synthesizing the second object appearance (e.g., the hand and forearm appearance depicting finger articulation, wrist orientation, etc.). In some embodiments, the pre-trained inpainting model can be re-trained using few-shot training, in which only a few examples are required to re-train the inpainting model.

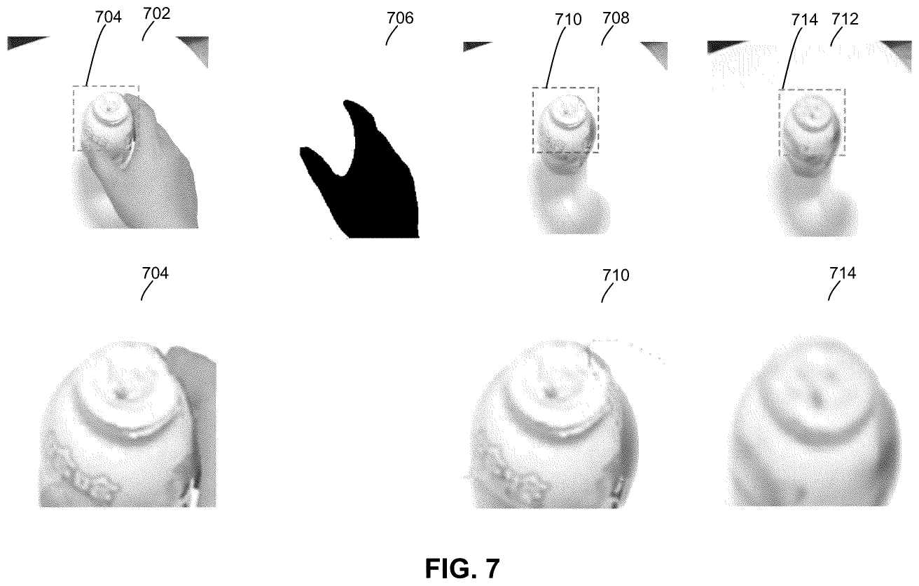

FIG. 7 illustrates how training images are generated for training the content model 152 of FIG. 1, according to various embodiments. In some embodiments, the content model 152 is trained separately from the layout model 150, but the content model 152 can be trained using training data that includes layout masks generated using the trained layout model 150. In such cases, the training data can further include pairs of (1) images that only include a first object, and (2) corresponding images of a second object interacting with the first object. The pairs of images need to be pixel-aligned except for regions associated with the second object. As shown in FIG. 7, one such pair of images can be generated starting from a ground truth image 702 of a first object. The ground truth image 702 can be used as the expected output during training of the content model 152. Illustratively, the ground truth image 702 includes a hand grasping a bottle. A region 704 of the ground truth image 702 is also shown in greater detail. Given the ground truth image 702, the model trainer 116 segments out the hand from the ground truth image 702 to generate a segmentation map 706 that indicates pixels corresponding to the second object, which is the hand in this example. In some embodiments, the model trainer 116 can apply a trained segmentation machine learning model to segment out the hand from the ground truth image 702 to generate the segmentation map 706.

After generating the segmentation map 706, the model trainer 116 inpaints a portion of the ground truth image 702 that the segmentation map 706 indicates corresponds to the hand to generate an inpainted image 708, in which the hand has been removed. In some embodiments, the model trainer 116 can apply a trained inpainting machine learning model to hallucinate the portion of the ground truth image 702 behind the second object, which is behind the hand in this example, thereby generating the inpainted image 708.

A region 710 of the inpainted image 708 is shown in greater detail. Illustratively, unwanted artifacts appear at a boundary of the region that was inpainted. If the content model 152 is trained using images with such artifacts, the content model 152 can learn to overfit to the artifacts. In some embodiments, the model trainer 116 processes inpainted images, such as the inpainted image 708, to remove artifacts therein. For example, in some embodiments, the model trainer 116 can process the inpainted images to remove artifacts by blurring the inpainted images, or by performing any other technically feasible image restoration technique. Illustratively, the inpainted image 708 is blurred to generate a blurred inpainted image 714. In some embodiments, the SDEdit technique can be applied to blur inpainted images. SDEdit first adds a small amount of noise to a given image and then denoises the resulting image to optimize overall image realism. A region 716 of the blurred inpainted image 714 is shown in greater detail. Illustratively, the artifacts have been blurred out in the region 716. However, because the blurred inpainted image 714 is blurry, and the content model 152 should not generate blurry images, a mixture of both inpainted images and blurred inpainted images can be used to train the content model 152 in some embodiments.

Using ground truth images (e.g., the ground truth image 702) as expected outputs and a mixture of inpainted images (e.g., the inpainted image 708) and inpainted images with artifacts removed (e.g., the blurred inpainted image 714) as inputs, the model trainer 116 can train a denoiser model (e.g., the denoiser model 614) to generate an image of objects interacting with one another noisy image. The mixture of the inpainted images and the inpainted images with artifacts removed can include using the inpainted images a certain percentage (e.g., 50%) of the time during training, and using the inpainted images with artifacts removed the other times during training. The trained denoiser model can then be used as the content model 152, described above in conjunction with FIGS. 1, 3, and 6.

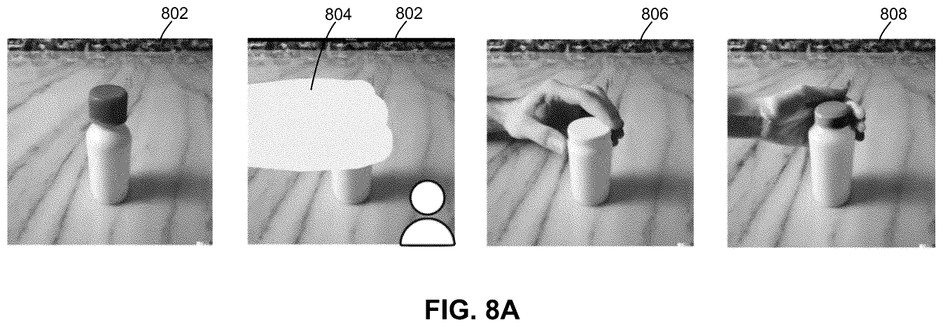

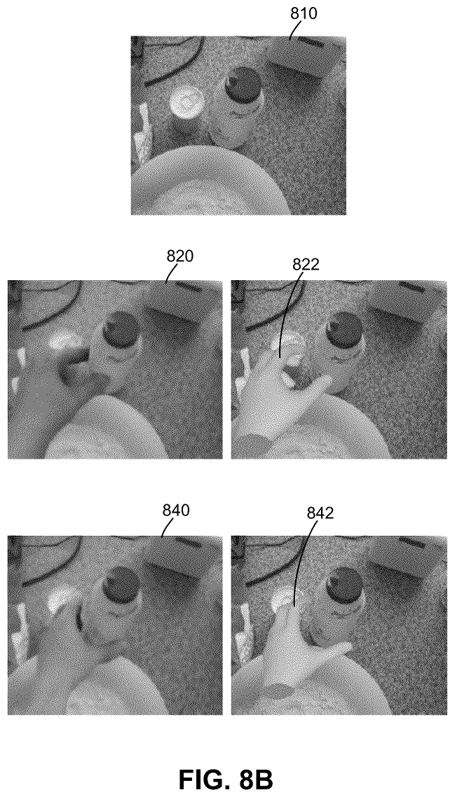

FIG. 8A illustrates an exemplar image generated using a denoising diffusion model, according to the prior art. As shown, a user can specify a region 804 within an image 802 that includes an object, shown as a bottle, and indicate that a hand should be within the region using the text prompt “A hand holding a bottle with blue cap on top of a marble table.” Given the image 802, the user-specified region 804, and the text prompt as inputs, a denoising diffusion model can be used to generate images of a hand grasping the bottle, such as images 806 and 808. However, a portion of the bottle being grasped is within the user-specified region 804. Accordingly, when the denoising diffusion model is used to regenerate the user-specified region 804, the portion of the bottle within the user-specified region 804 is replaced by what the denoising diffusion model generates. In such cases, the portion of the bottle in the regenerated region can be different from the original portion of the bottle in the user-specified region 804 of the image 802. Illustratively, the cap of the bottle in the images 806 and 808 have different appearances than the cap of the bottle in the image 802. For example, the cap of the bottle in the image 806 is white, rather than blue.

FIG. 8B illustrates exemplar images generated using a layout model in conjunction with a content model, according to various embodiments. As shown, given an image 810 of a bottle as input, the layout model 150 and the content model 152, described above in conjunction with FIGS. 1, 3-4, and 6, can be used to generate images 820 and 840 that each include a hand interacting with the bottle from the image 810. Illustratively, the bottle has the same appearance in the generated images 820 and 840 as in the input image 810. Also shown are 3D geometries 822 and 842 that can be generated from the images 820 and 840 using known techniques, such as off-the-shelf hand pose estimators.

Experience has shown that the layout model 150 and the content model 152 can be used to generate diverse images of objects interacting with one another, such as diverse articulations of a hand grasping an object. For example, FIG. 8B illustrates two images 820 and 840 that include different hand articulations for the same input image 810 of a bottle. 3D information, such as the 3D geometries 822 and 842, can also be estimated from images of object interactions generated using the layout model 150 and the content model 152. In addition, the layout model 150 and the content model 152 can be used to generate scene-level interactions between objects by cropping out regions of an original image that each includes a different object, generating new content that includes object interactions for each of the regions, and combining the generated content for the regions with the original image. In such cases, the sizes of the objects (e.g., the size of a hand) can be kept fixed for consistency purposes.

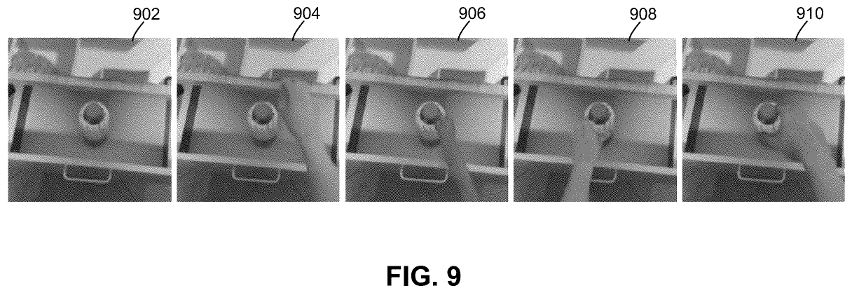

FIG. 9 illustrates another exemplar image generated using a layout model in conjunction with a content model, according to various embodiments. As shown, for an input image 902 that includes a bottle, images 904, 906, and 908 of a hand grabbing the bottle were generated using the conventional latent diffusion model (LDM), Pix2Pix model, and variational autoencoder (VAE) model, respectively. Image 910 was generated using the layout model 150 and the content model 152, described above in conjunction with FIGS. 1, 3-4, and 6. Illustratively, the Pix2Pix model generated an image 904 that lacks detailed finger articulation. While the LDM and VAE models generated images 902 and 906 that include more realistic hand articulations than the image 904 generated by the Pix2Pix model, the appearance of the hand near the region of contact between the hand and the bottle is not particularly realistic in the images 902 and 906. Further, in the image 902 generated using LDM, the hand does not make contact with the bottle. In some cases, LDM will not add a hand to an image at all. Relative to the images 904, 906, and 908, the image 910 generated using the layout model 150 and the content model 152 includes a hand with a more plausible articulation and more realistic regions of contact between the hand and the bottle.

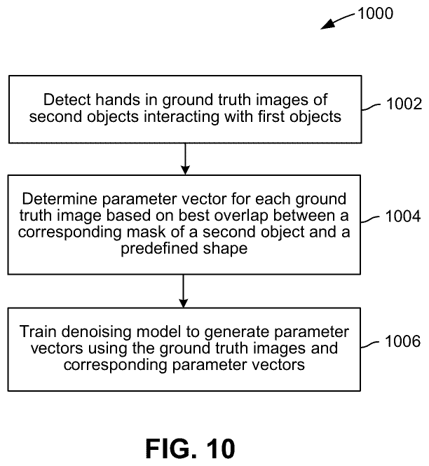

FIG. 10 is a flow diagram of method steps for training a layout model to generate a mask indicating the spatial arrangement of two interacting objects, according to various embodiments. Although the method steps are described in conjunction with the system of FIGS. 1-6, persons skilled in the art will understand that any system configured to perform the method steps in any order falls within the scope of the present embodiments.

As shown, a method 1000 begins at step 1002, where the model trainer 116 detects hands in ground truth images of second objects interacting with first objects. As described, the second objects can be human hands in some embodiments.

At step 1004, the model trainer 116 determines a parameter vector for each ground truth image based on a best overlap between a corresponding mask of the second object and a predefined shape. In some embodiments in which the second object is a hand, the predefined shape can be a lollipop that includes a circle connected to a stick, and the parameter vector can include parameters indicating a layout of the second object interacting with the first object, such as the size, position, and/or approaching direction of the second object

At step 1006, the model trainer 116 trains a denoiser model to generate parameter vectors using the ground truth images and corresponding parameter vectors. In some embodiments, the denoiser model can be trained using the loss function of equation (3), as described above in conjunction with FIG. 4. In some embodiments, the trained denoiser model can be used in the layout model 150, described above in conjunction with FIGS. 1 and 3-4.

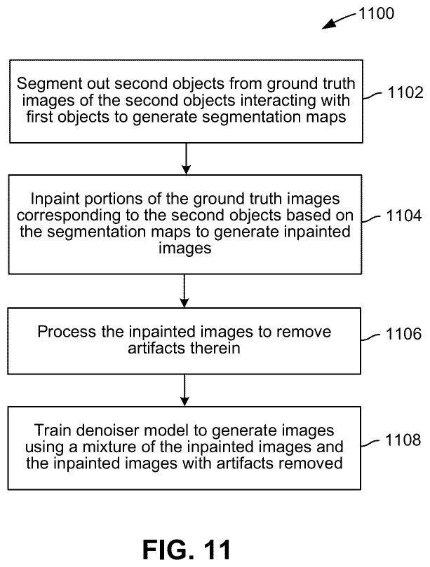

FIG. 11 is a flow diagram of method steps for training a content model to generate an image of objects interacting with one another, according to various embodiments. Although the method steps are described in conjunction with the system of FIGS. 1-6, persons skilled in the art will understand that any system configured to perform the method steps in any order falls within the scope of the present embodiments.

As shown, a method 1100 begins at step 1102, where the model trainer 116 segments out second objects from ground truth images of the second objects interacting with first objects to generate segmentation maps. For example, the second objects can be human hands in some embodiments.

At step 1104, the model trainer 116 inpaints portions of the ground truth images corresponding to the second objects based on the segmentation maps to generate inpainted images. In some embodiments, the model trainer 116 can input the ground truth images and the corresponding segmentation maps into an inpainting machine learning model that inpaints the portions of the ground truth image corresponding to the second objects.

At step 1106, the model trainer 116 processes the inpainted images to remove artifacts therein. In some embodiments, the model trainer 116 process the inpainted images in any technically feasible manner, such as by performing image restoration on the inpainted images using known techniques such as SDEdit, to remove artifacts in the inpainted images.

At step 1108, the model trainer 116 trains a denoiser model to generate images using a mixture of the inpainted images and the inpainted images with artifacts removed. The mixture of the inpainted images and the inpainted images with artifacts removed can include using the inpainted images a certain percentage (e.g., 50%) of the time during training, and using the inpainted images with artifacts removed the other times during training, as described above in conjunction with FIG. 7. In some embodiments, the trained denoiser model can be used as the content model 152, described above in conjunction with FIGS. 1, 3, and 6.

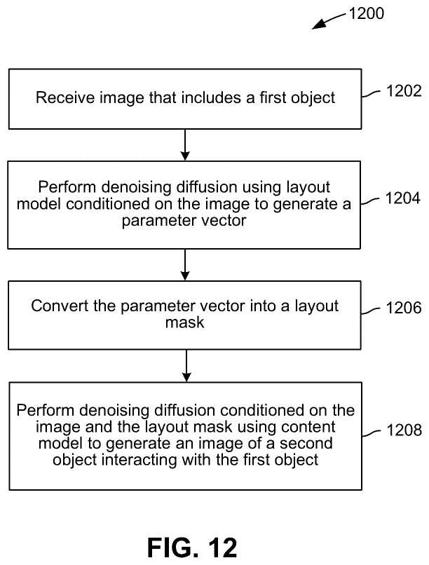

FIG. 12 is a flow diagram of method steps for generating an image of objects interacting with one another, according to various embodiments. Although the method steps are described in conjunction with the system of FIGS. 1-6, persons skilled in the art will understand that any system configured to perform the method steps in any order falls within the scope of the present embodiments.

As shown, a method 1200 begins at step 1202, where the image generating application 146 receives an image that includes a first object.

At step 1204, the image generating application 146 performs denoising diffusion using the layout model 150 conditioned on the received image to generate a parameter vector. In some embodiments, the denoising diffusion can include, for each of a number of time steps, computing a denoised parameter vector by inputting a noisy parameter vector at the time step into the trained denoiser model 422, until a parameter vector that does not include noise, is generated, as described above in conjunction with FIG. 4. In some embodiments, the parameter vector includes parameters indicating a layout of the second object interacting with the first object, such as the size, position, and/or approaching direction of the second object. For example, when the second object is a human hand, the parameter vector 304 can include as parameters a hand palm size, a location, an approaching direction, and a ratio of the hand palm size and a forearm width.

At step 1206, the image generating application 146 converts the parameter vector into a layout mask. In some embodiments, the image generating application 146 inputs the parameter vector into a trained machine learning model, such as a spatial transformer network, that generates the layout mask.

At step 1208, the image generating application 146 performs denoising diffusion conditioned on the image and the layout mask using the content model 152 to generate an image of a second object interacting with the first object. In some embodiments, the denoising diffusion can include, for each of a fixed number of time steps, computing a denoised image by inputting a noisy image at the time step into the trained denoiser model 422.

In sum, techniques are disclosed for generating images of objects interacting with one another. Given an input image that includes a first object, an image generating application performs denoising diffusion using a layout model and conditioned on the input image to generate a vector of parameters that indicates a spatial arrangement of a second object interacting with the first object. Then, the image generating application converts the vector of parameters into a layout mask and performs denoising diffusion using a content model and conditioned on (1) the input image, and (2) the layout mask to generate an image of the second object interacting with the first object. In some embodiments, a user can also input a location associated with the second object. In such cases, the image generating application performs denoising diffusion using the layout model and conditioned on (1) the input image, and (2) the input location to generate the vector of parameters, which can then be used to generate an image of the second object interacting with the first object.

At least one technical advantage of the disclosed techniques relative to the prior art is that, with the disclosed techniques, an image of objects interacting with one another can be generated without changing the appearance of any of the objects. In addition, the disclosed techniques enable the automatic generation of images that include more realistic interactions between objects, such as a human hand or other body part interacting with an object, relative to what can be achieved using conventional techniques. These technical advantages represent one or more technological improvements over prior art approaches.

1. In some embodiments, a computer-implemented method for generating an image comprises performing one or more first denoising operations based on a first machine learning model and an input image that includes a first object to generate a mask that indicates a spatial arrangement associated with a second object interacting with the first object, and performing one or more second denoising operations based on a second machine learning model, the input image, and the mask to generate an image of the second object interacting with the first object.

2. The computer-implemented method of clause 1, further comprising receiving an input position associated with the second object, wherein the one or more first denoising operations are further based on the input position.

3. The computer-implemented method of clauses 1 or 2, wherein performing the one or more first denoising operations comprises performing one or more operations to convert a first parameter vector into an intermediate mask, performing the one or more denoising diffusion operations based on the intermediate mask, the input image, and a denoiser model to generate a second parameter vector, and performing one or more operations to convert the second parameter vector into the mask.

4. The computer-implemented method of any of clauses 1-3, wherein each of the one or more first denoising operations and the one or more second denoising operations includes one or more denoising diffusion operations.

5. The computer-implemented method of any of clauses 1-4, wherein the first machine learning model comprises a spatial transformer neural network and an encoder neural network.

6. The computer-implemented method of any of clauses 1-5, wherein the second machine learning model comprises an encoder-decoder neural network.

7. The computer-implemented method of any of clauses 1-6, wherein the second object comprises a portion of a human body.

8. The computer-implemented method of any of clauses 1-7, further comprising performing one or more operations to generate three-dimensional geometry corresponding to the second object as set forth in the image of the second object interacting with the first object.

9. The computer-implemented method of any of clauses 1-8, further comprising detecting the second object as set forth in one or more training images of the second object interacting with the first object, determining one or more training parameter vectors based on the one or more training images and the second object detected in the one or more training images, and performing a plurality of operations to train the first machine learning model based on the one or more training images and the one or more training parameter vectors.

10. The computer-implemented method of any of clauses 1-9, further comprising performing more operations to separate the second object from one or more training images to generate one or more segmented images, inpainting one or more portions of the one or more training images based on the one or more segmented images to generate one or more inpainted images, performing one or more operations to remove one or more artifacts from the one or more inpainted images to generate one or more inpainted images with artifacts removed, and training the second machine learning model based on the one or more training images, the one or more inpainted images, and the one or more inpainted images with artifacts removed.

11. In some embodiments, one or more non-transitory computer-readable media storing instructions that, when executed by at least one processor, cause the at least one processor to perform steps for generating an image, the steps comprising performing one or more first denoising operations based on a first machine learning model and an input image that includes a first object to generate a mask that indicates a spatial arrangement associated with a second object interacting with the first object, and performing one or more second denoising operations based on a second machine learning model, the input image, and the mask to generate an image of the second object interacting with the first object.

12. The one or more non-transitory computer-readable media of clause 11, wherein the instructions, when executed by the at least one processor, further cause the at least one processor to perform the step of receiving an input position associated with the second object, wherein the one or more first denoising operations are further based on the input position.

13. The one or more non-transitory computer-readable media of clauses 11 or 12, wherein performing the one or more first denoising operations comprises performing one or more operations to convert a first parameter vector into an intermediate mask, performing the one or more denoising diffusion operations based on the intermediate mask, the input image, and a denoiser model to generate a second parameter vector, and performing one or more operations to convert the second parameter vector into the mask.

14. The one or more non-transitory computer-readable media of any of clauses 11-13, wherein the first machine learning model comprises a spatial transformer machine learning model and an encoder machine learning model.

15. The one or more non-transitory computer-readable media of any of clauses 11-14, wherein the second machine learning model comprises an encoder-decoder machine learning model.

16. The one or more non-transitory computer-readable media of any of clauses 11-15, wherein the instructions, when executed by the at least one processor, further cause the at least one processor to perform the step of performing one or more operations to generate three-dimensional geometry corresponding to the second object as set forth in the image of the second object interacting with the first object.

17. The one or more non-transitory computer-readable media of any of clauses 11-16, wherein the second object comprises a human hand.

18. The one or more non-transitory computer-readable media of any of clauses 11-17, wherein the instructions, when executed by the at least one processor, further cause the at least one processor to perform the steps of detecting the second object as set forth in one or more training images of the second object interacting with the first object, determining one or more training parameter vectors based on the one or more training images and the second object detected in the one or more training images, and performing a plurality of operations to train the first machine learning model based on the one or more training images and the one or more training parameter vectors.

19. The one or more non-transitory computer-readable media of any of clauses 11-18, wherein the instructions, when executed by the at least one processor, further cause the at least one processor to perform the steps of performing more operations to separate the second object from one or more training images to generate one or more segmented images, inpainting one or more portions of the one or more training images based on the one or more segmented images to generate one or more inpainted images, performing one or more operations to remove one or more artifacts from the one or more inpainted images to generate one or more inpainted images with artifacts removed, and training the second machine learning model based on the one or more training images, the one or more inpainted images, and the one or more inpainted images with artifacts removed.

20. In some embodiments, a system comprises one or more memories storing instructions, and one or more processors that are coupled to the one or more memories and, when executing the instructions, are configured to perform one or more first denoising operations based on a first machine learning model and an input image that includes a first object to generate a mask that indicates a spatial arrangement associated with a second object interacting with the first object, and perform one or more second denoising operations based on a second machine learning model, the input image, and the mask to generate an image of the second object interacting with the first object.

Any and all combinations of any of the claim elements recited in any of the claims and/or any elements described in this application, in any fashion, fall within the contemplated scope of the present disclosure and protection.

The descriptions of the various embodiments have been presented for purposes of illustration, but are not intended to be exhaustive or limited to the embodiments disclosed. Many modifications and variations will be apparent to those of ordinary skill in the art without departing from the scope and spirit of the described embodiments.

Aspects of the present embodiments may be embodied as a system, method or computer program product. Accordingly, aspects of the present disclosure may take the form of an entirely hardware embodiment, an entirely software embodiment (including firmware, resident software, micro-code, etc.) or an embodiment combining software and hardware aspects that may all generally be referred to herein as a “module” or “system.” Furthermore, aspects of the present disclosure may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

Aspects of the present disclosure are described above with reference to flowchart illustrations and/or block diagrams of methods, apparatus (systems) and computer program products according to embodiments of the disclosure. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine. The instructions, when executed via the processor of the computer or other programmable data processing apparatus, enable the implementation of the functions/acts specified in the flowchart and/or block diagram block or blocks. Such processors may be, without limitation, general purpose processors, special-purpose processors, application-specific processors, or field-programmable gate arrays.

The flowchart and block diagrams in the figures illustrate the architecture, functionality, and operation of possible implementations of systems, methods and computer program products according to various embodiments of the present disclosure. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

While the preceding is directed to embodiments of the present disclosure, other and further embodiments of the disclosure may be devised without departing from the basic scope thereof, and the scope thereof is determined by the claims that follow.

What is claimed is:

1. A computer-implemented method for generating an image, the method comprising:
performing one or more first denoising operations based on a first machine learning model and an input image that includes a first object to generate a mask that indicates a spatial arrangement associated with a second object interacting with the first object; and
performing one or more second denoising operations based on a second machine learning model, the input image, and the mask to generate an image of the second object interacting with the first object.

2. The computer-implemented method of claim 1, further comprising receiving an input position associated with the second object, wherein the one or more first denoising operations are further based on the input position.

3. The computer-implemented method of claim 1, wherein performing the one or more first denoising operations comprises:
performing one or more operations to convert a first parameter vector into an intermediate mask;
performing the one or more denoising diffusion operations based on the intermediate mask, the input image, and a denoiser model to generate a second parameter vector; and
performing one or more operations to convert the second parameter vector into the mask.

4. The computer-implemented method of claim 1, wherein each of the one or more first denoising operations and the one or more second denoising operations includes one or more denoising diffusion operations.

5. The computer-implemented method of claim 1, wherein the first machine learning model comprises a spatial transformer neural network and an encoder neural network.

6. The computer-implemented method of claim 1, wherein the second machine learning model comprises an encoder-decoder neural network.

7. The computer-implemented method of claim 1, wherein the second object comprises a portion of a human body.

8. The computer-implemented method of claim 1, further comprising performing one or more operations to generate three-dimensional geometry corresponding to the second object as set forth in the image of the second object interacting with the first object.

9. The computer-implemented method of claim 1, further comprising:
detecting the second object as set forth in one or more training images of the second object interacting with the first object;
determining one or more training parameter vectors based on the one or more training images and the second object detected in the one or more training images; and
performing a plurality of operations to train the first machine learning model based on the one or more training images and the one or more training parameter vectors.

10. The computer-implemented method of claim 1, further comprising:
performing more operations to separate the second object from one or more training images to generate one or more segmented images;
inpainting one or more portions of the one or more training images based on the one or more segmented images to generate one or more inpainted images;
performing one or more operations to remove one or more artifacts from the one or more inpainted images to generate one or more inpainted images with artifacts removed; and
training the second machine learning model based on the one or more training images, the one or more inpainted images, and the one or more inpainted images with artifacts removed.

11. One or more non-transitory computer-readable media storing instructions that, when executed by at least one processor, cause the at least one processor to perform steps for generating an image, the steps comprising:
performing one or more first denoising operations based on a first machine learning model and an input image that includes a first object to generate a mask that indicates a spatial arrangement associated with a second object interacting with the first object; and
performing one or more second denoising operations based on a second machine learning model, the input image, and the mask to generate an image of the second object interacting with the first object.

12. The one or more non-transitory computer-readable media of claim 11, wherein the instructions, when executed by the at least one processor, further cause the at least one processor to perform the step of receiving an input position associated with the second object, wherein the one or more first denoising operations are further based on the input position.

13. The one or more non-transitory computer-readable media of claim 11, wherein performing the one or more first denoising operations comprises:
performing one or more operations to convert a first parameter vector into an intermediate mask;
performing the one or more denoising diffusion operations based on the intermediate mask, the input image, and a denoiser model to generate a second parameter vector; and
performing one or more operations to convert the second parameter vector into the mask.

14. The one or more non-transitory computer-readable media of claim 11, wherein the first machine learning model comprises a spatial transformer machine learning model and an encoder machine learning model.

15. The one or more non-transitory computer-readable media of claim 11, wherein the second machine learning model comprises an encoder-decoder machine learning model.

16. The one or more non-transitory computer-readable media of claim 11, wherein the instructions, when executed by the at least one processor, further cause the at least one processor to perform the step of performing one or more operations to generate three-dimensional geometry corresponding to the second object as set forth in the image of the second object interacting with the first object.

17. The one or more non-transitory computer-readable media of claim 11, wherein the second object comprises a human hand.

18. The one or more non-transitory computer-readable media of claim 11, wherein the instructions, when executed by the at least one processor, further cause the at least one processor to perform the steps of:
detecting the second object as set forth in one or more training images of the second object interacting with the first object;
determining one or more training parameter vectors based on the one or more training images and the second object detected in the one or more training images; and
performing a plurality of operations to train the first machine learning model based on the one or more training images and the one or more training parameter vectors.

19. The one or more non-transitory computer-readable media of claim 11, wherein the instructions, when executed by the at least one processor, further cause the at least one processor to perform the steps of:
performing more operations to separate the second object from one or more training images to generate one or more segmented images;
inpainting one or more portions of the one or more training images based on the one or more segmented images to generate one or more inpainted images;
performing one or more operations to remove one or more artifacts from the one or more inpainted images to generate one or more inpainted images with artifacts removed; and
training the second machine learning model based on the one or more training images, the one or more inpainted images, and the one or more inpainted images with artifacts removed.

20. A system, comprising:
one or more memories storing instructions; and
one or more processors that are coupled to the one or more memories and, when executing the instructions, are configured to:
perform one or more first denoising operations based on a first machine learning model and an input image that includes a first object to generate a mask that indicates a spatial arrangement associated with a second object interacting with the first object, and
perform one or more second denoising operations based on a second machine learning model, the input image, and the mask to generate an image of the second object interacting with the first object.
